(19) United States
(12) Patent Application Publication
(10) Pub. No.: US 2014/0145467 A1
(43) Pub. Date: May 29, 2014

(54) AERODYNAMIC TRAILER SKIRT

(71) Applicant: Gary C.L. Ellis, Chatham (CA)

(72) Inventor: Gary C.L. Ellis, Chatham (CA)

(21) Appl. No.: 13/860,935

(22) Filed: Apr. 11, 2013

Related U.S. Application Data
(60) Provisional application No. 61/622,579, filed on Apr. 11, 2012.

(51) Int. Cl. B62D 35/00

(52) U.S. Cl. CPC B62D 35/001
USPC 296/180.4

(57) ABSTRACT

A mechanism comprising of a trailer skirt for attachment beneath a lower, outer longitudinally extending edge of a trailer, containing a plurality dimples disposed upon a planar surface of the skirt, thereby improving aerodynamic efficiency. The plurality of dimples may have any number of shapes, including a variety of multi-sided polygonally shaped depressions. In one embodiment, the depressions have a plurality of frusto-spherical shaped depressions.

### CROSS-REFERENCE TO RELATED APPLICATIONS

This application claims the benefit of U.S. Provisional Application 61/622,579, filed Apr. 11, 2012. The entire disclosure of the above application is incorporated herein by reference.

### FIELD

The present disclosure relates to a mechanism and system for reducing drag and for improving the aerodynamic characteristics of a motor vehicle. In particular, the invention relates to a mechanism comprising of a trailer skirt for attachment beneath a lower, outer longitudinally extending edge of a trailer.

### SUMMARY

This section provides a general summary of the disclosure, and is not a comprehensive disclosure of its full scope or all of its features.

According to the present invention, there is provided a trailer skirt comprising an upper edge for securing the trailer skirt to the trailer, a lower edge, and an elongated planar surface extending from the upper edge to the lower edge. Disposed within the elongated planar surface is a plurality of dimples. The elongated planar surface may have a monolithic structure. Alternatively, the elongated planar surface may have a plurality of panels configured and arranged in side-by-side, abutting connection with one another. The upper edge may have a flange extending inwards to toward the interior of the trailer, with the elongated planar surface being substantially co-planar with an outer wall of the trailer.

The trailer skirt may further have a rear edge extending to the rear tires of the trailer and a front edge extending to the front tires of the trailer. The rear edge may have a concave curve shape substantially corresponding to the shape of a rear tire of the trailer, and the front edge may have a convex curve shape.

The plurality of dimples may have inward depressions, protrusions or indentations formed upon the elongated planar surface. Furthermore, the plurality of dimples may have multiple shapes, including multi-sided polygonally shaped depressions. According to one embodiment, the plurality of dimples are frusto-spherical shaped depressions. The diameters of the frusto-spherical shaped depressions may range from 3-4 inches, and according to one embodiment, the diameter of the frusto-conical shaped depressions is 3⅛ inches.

The plurality of dimples may be a matrix of substantially symmetrical dimples, dispersed symmetrically across the elongated planar surface. The vertical distance from the center of one dimple to the vertically adjacent dimple may be fixed, and likewise the horizontal distance from the center of one dimple to the horizontally adjacent dimple may also be fixed. According to one embodiment, the fixed vertical distance from the center of one dimple to the vertically adjacent dimple is 2⅜ inches and the fixed horizontal distance from the center of one dimple to the horizontally adjacent dimple is 2⅜ inches. Each dimple may have a fixed depth, and according to one embodiment, the fixed depth of each dimple is ¼ inch. Furthermore, according to one embodiment, the elongated planar surface has a thickness of ⅜ inches, and a height of 2 foot, 9 inches.

The trailer skirt according to the present teachings may be formed from a composite thermoplastic. In one embodiment, the composite thermoplastic comprises a continuous fiber reinforced thermoplastic.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side view of the trailer with trailer skirt attached in its typical functional position;

FIG. 2 is an enlarged side view of the trailer skirt;

FIG. 3 is a cross-sectional view of the trailer skirt;

FIG. 4 is an enlarged view of the trailer skirt demonstrating dimples; and

FIG. 5 is a side view of the trailer with an alternate embodiment of trailer skirt, in which the trailer skirt is formed with a plurality of panels.

Corresponding reference numerals indicate corresponding parts throughout the several views of the drawings.

### DETAILED DESCRIPTION

Example embodiments will now be described more fully with reference to the accompanying drawings.

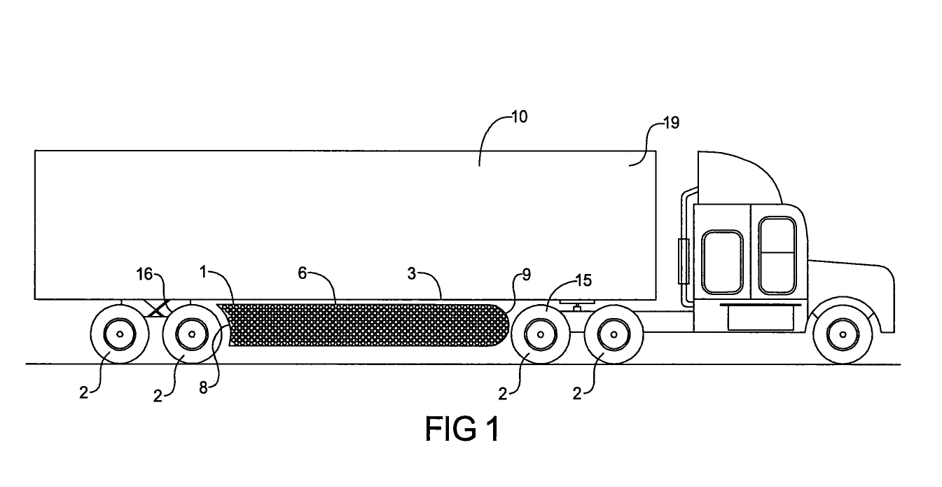

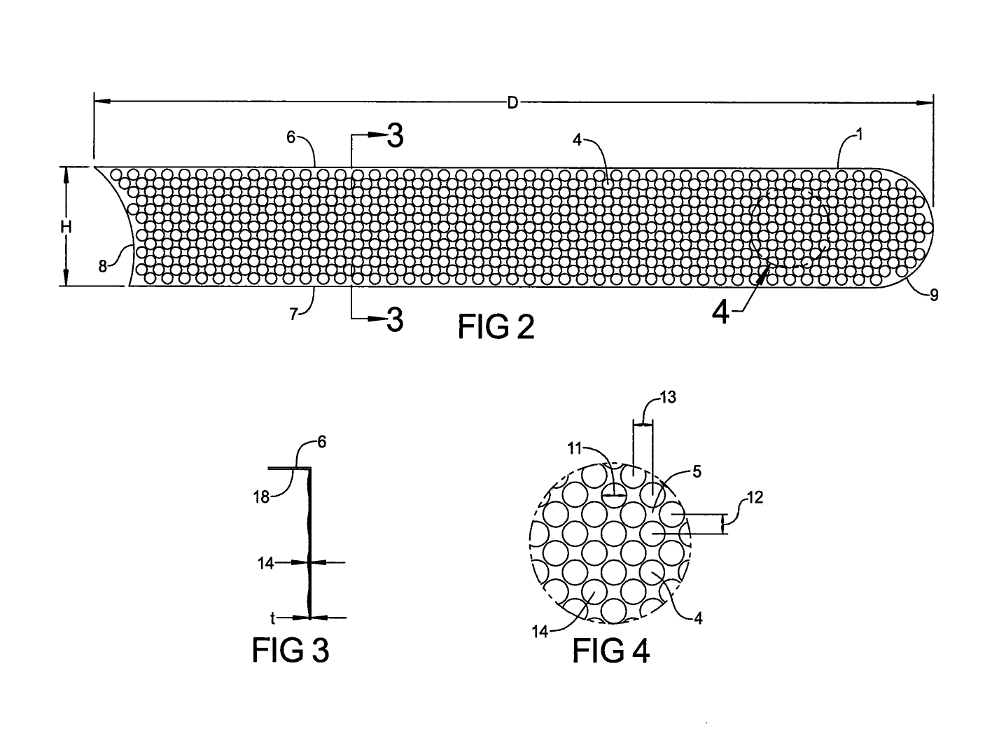

The trailer skirt 1 according to the present teachings is generally illustrated in FIGS. 1 and 2. Referring to FIG. 1, the trailer skirt 1 attaches to a bottom, outer edge of a trailer, and individual skirt assemblies can be attached to both the left and right sides of the trailer. Trailer skirts have been generally used to improve aerodynamic efficiency of tractor-trailer trucks in operation, by streamlining airflow away from the underside of the trailer and around the sides.

The trailer skirt 1 is positioned between the wheels 2, and specifically, the front wheels 15 and rear wheels 16, of a trailer 10 and extends downward from the outer bottom edge of the trailer 10, providing a continuous surface for shielding air flow and preventing air flow from travelling below the trailer.

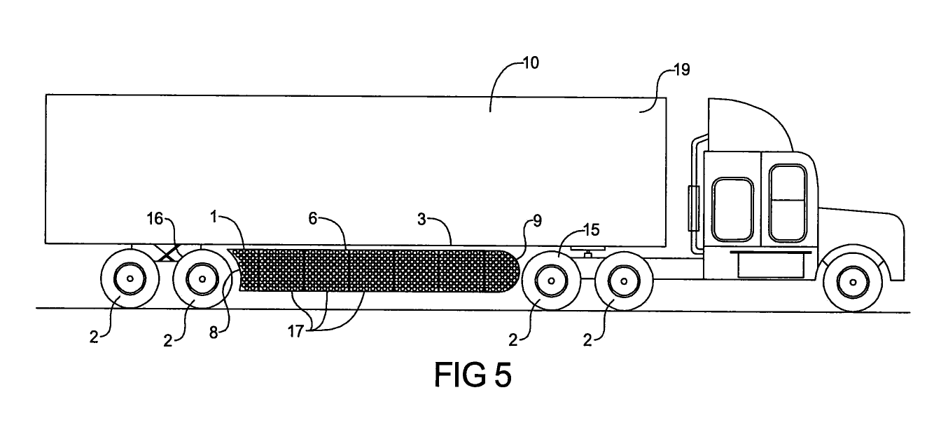

The trailer skirt 1 extends downward from the bottom outer edge of the trailer towards the road surface, thereby directing air laterally along the skirt surface and along the side of the trailer. The trailer skirt 1 may be formed as a monolithic structure, generally rectangular shaped structure, forming a continuous surface which extends longitudinally along the side of the trailer. As illustrated in FIGS. 1 and 2, the trailer skirt may be formed as one long, continuous structure extending substantially the entire distance between the front and rear wheels 15, 16 of trailer 10. However, in alternative embodiments, as demonstrated in FIG. 5, the trailer skirt 1 can be formed as a shorter, generally rectangular shaped panel 17, with several panels being configured and arranged side-by-side and abutting connection with one another. The several connected panels form one, continuous fairing extending substantially the entire distance between the front and rear 15, 16 wheels of the trailer 10.

With reference to FIGS. 1 and 3, the upper edge 6 of trailer skirt 1 attaches to bottom edge 3 of trailer 10, thereby securing trailer skirt 1 to trailer 10. Various forms of securing members or mechanisms are well known in the art, and any one of these mechanisms can be used to secure the trailer skirt 1 to the trailer 10. With reference to the embodiment depicted in FIG. 3, upper edge 6 has a flange 18 extending inward towards the interior of trailer 10 from planar surface 5. The flange 18 has upper edge 6 and can be fastened to bottom edge 3 of trailer 10 using various forms of fastening mechanisms such as rivets, screws or bolts. Ideally, trailer skirt 1 is fastened and positioned between the wheels 2 of trailer 10, as depicted in FIG. 1. Furthermore, trailer skirt 1 may be positioned on each side of trailer 10 simultaneously. The elongated planar surface 5 extends downward from bottom edge 3 of trailer 10 and may be substantially co-planar with the outer wall 19 of trailer 10.

As seen in FIG. 2, the trailer skirt 1 has a longitudinal length D and a height H, which height H is equivalent to the distance between upper edge 6 and bottom edge 7. With reference to the embodiment illustrated in FIG. 3, the flange upper edge 6 is approximately 5 inches in length. Furthermore, with reference to the embodiment illustrated in FIGS. 2 and 3, elongated planar surface 5 has a thickness t of approximately ⅜ inches. Height H of trailer skirt 1 is approximately 2 foot, 9 inches in length.

When installed, trailer skirt 1 channels air flow around trailer 10 in order to reduce drag while the trailer 10 is in motion. The trailer skirt 1 may have a rear edge 8 extending to the rear tires 16 of the trailer and a front edge 9 extending to the front tires 15 of the trailer. As illustrated in FIGS. 1 and 2, rear edge 8 of trailer skirt 1 may be designed in the shape of a concave curve, substantially corresponding to the shape of the rear tires 16 of the trailer 10, thereby allowing trailer skirt 1 to extend as closely to the rear wheels of trailer 10 as possible and minimizing the amount of air flow passing beneath trailer 10. Front edge 9 of trailer skirt 1 is shown in FIGS. 1 and 2 as having a convex, curve shape. However, the shape of the front edge 9 and rear edge 8 of trailer skirt are optional and can be configured to maximize aerodynamic efficiency, for example, with both front edge 9 and rear edge 8 having concave shapes, or both front edge 9 and rear edge 8 having convex shapes.

As illustrated in FIG. 2, disposed upon the elongated planar surface 5 of trailer skirt 1 is a plurality of dimples 4, said plurality of dimples comprising inward depressions, protrusions or indentations formed upon the elongated planar surface 5. The dimples 4 are formed directly upon trailer skirt 1 during the forming process, as the entire trailer skirt 1 (or correspondingly, each individual panel as illustrated in FIG. 5) can be formed as one molded piece or pressed as one sheet, with the dimples formed intrinsically thereupon. As described in greater detail below, the presence of said dimples reduces air drag around the trailer 10, and provides greater aerodynamic efficiency in comparison to standard trailer skirts known in the art.

The trailer skirt 1 may be formed from any suitable thermoplastic or composite thermoplastic known in the art that provides semi-rigid qualities and allows the trailer skirt 1 to maintain shape while permitting some flexure during use. For example, trailer skirt 1 may be formed from a continuous fiber reinforced thermoplastic, such as Polystrand®, and may be formed using a thermoforming molding operation. Although a thermoforming process is the preferred method of forming trailer skirt 1, one skilled in the art would appreciate that this is one of several different methods that may be utilized, which methods may include injection molding or compression molding, and that any such methods would fall within the scope of the present invention.

The plurality of dimples 4 may have multiple shapes, including various forms of multi-sided polygonally shaped depressions. As illustrated in the preferred embodiment of FIGS. 2 and 4, the plurality of dimples have frusto-spherical shaped depressions, comprising a matrix of substantially symmetrical dimples, dispersed symmetrically across the elongated planar surface 5.

Referring to FIG. 4, the dimples 4 can range in depth 14 depending on length D of trailer skirt 1, height H of trailer skirt 1, and conditions of use such as weather conditions in order to maximize aerodynamic efficiency. Similarly, diameter 11 of each dimple 4, as well as vertical distance 12 and horizontal distance 13 between the centers of dimples 4 can also be configured depending on similar variables. In the embodiment of FIG. 4, the vertical distance from the center of one dimple to the vertically adjacent dimple is fixed. Similarly, the horizontal distance from the center of one dimple to the horizontally adjacent dimple is fixed.

With reference to the embodiment illustrated in FIG. 4, the diameter 11 of each dimple may range from 3-4 inches, with the preferred embodiment having a diameter of approximately 3⅛ inches. Furthermore, the vertical distance 12 from the center of one dimple to the next adjacent dimple, as well as the horizontal distance 13 from the center of one dimple to the next adjacent dimple is approximately 2⅜″. The depth of each dimple 4 may be fixed, with the depth of the dimples 4 of the embodiment of FIG. 4 being ¼″.

The function of the dimples 4 shall now be described in detail. Aerodynamic efficiency of a body moving through a fluid medium can be maximized through various methods. Primarily, the shape of an elongated body moving through a fluid medium can be streamlined so as to minimize form drag. Apart from form drag, which primarily relates to the shape of the body passing through the fluid medium, pressure drag pertains to fluid flow along the surface of the body, and the effects of the separation of fluid flow from the surface of the body.

As fluid, in this case air flow, moves along the surface of trailer skirt 1, the boundary layer of air along the surface of trailer skirt 1 moves from areas of high pressure to lower pressure. At a certain distance from front edge 9 of trailer skirt 1, the pressure differential causes the boundary layer of laminar air flow to separate from the surface of trailer skirt 1, resulting in a turbulent wake forming in the space behind the point of separation. The turbulent wake formed at the point of separation causes a stark air pressure gradient, and the force of this air pressure causes significant drag on trailer 10, thereby reducing aerodynamic efficiency.

The inclusion of dimples 4 onto the elongated planar surface 5 of trailer skirt 1 causes disruption to the laminar flow of the boundary layer, thereby causing the boundary layer flow to become turbulent, a process referred to in the art as a boundary layer tripping. The turbulent boundary layer has more kinetic energy than a laminar boundary layer. As such, the flow of the turbulent boundary layer, having greater energy and momentum than a laminar boundary layer, is able to overcome the pressure gradient for a longer period than a laminar flow, and will remain adhered to the surface of trailer skirt 1 for a greater period of time, and a greater distance along trailer skirt 1 from front edge than a laminar flow.

The increase in boundary layer adhesion results resulting from tripping the boundary in a significant reduction in the magnitude of the turbulent wake formation in comparison to the situation of laminar flow separation. This increase in boundary layer adhesion creates an overall increase in aerodynamic efficiency-decreasing the turbulent wake caused by laminar flow separation by tripping the boundary layer allows the turbulent boundary layer to travel further along the surface of trailer skirt 1 against the pressure gradient, thereby causing an overall reduction in pressure drag. Lower drag will increase the overall aerodynamic performance of the trailer 10 in use, resulting in greater fuel economy.

Trailer skirt 1 improves aerodynamic efficiency of the trailer 10 by directing air flow and the corresponding turbulent wake around to the rear of the trailer, which air flow would otherwise result in a turbulent wake forming below trailer 10 causing significant drag. Furthermore, the inclusion of dimples 4 upon the elongated planar surface 5 of trailer skirt 1 causes a significant reduction in pressure drag. The aerodynamic efficiency improvements created by trailer skirt 1 assist in improving overall fuel efficiency of trailer 10, leading to greater fuel economy and engine maintenance. It is envisioned the trailer skirt 1 can have a coating of a low friction paint which can decrease wind resistance and may help keep the dimples clean.

While the invention has been described in connection with what is presently considered to be the most practical and preferred embodiments, it is to be understood that the invention is not to be limited to the disclosed embodiments and elements, but, to the contrary, is intended to cover various modifications, combinations of features, equivalent arrangements, and equivalent elements included within the spirit and scope of the appended claims. Furthermore, the dimensions of features of various components that may appear on the drawings are not meant to be limiting, and the size of the components therein can vary from the size that may be portrayed in the figures herein. Thus, it is intended that the present invention covers the modifications and variations of the invention, provided they come within the scope of the appended claims and their equivalents.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A trailer skirt comprising:
an upper edge for securing the trailer skirt to a trailer;
a lower edge;
an elongated planar surface extending from the upper edge to the lower edge; and
a plurality of dimples, defined within the elongated planar surface.

2. The trailer skirt according to claim 1, wherein the elongated planar surface comprises a monolithic structure.

3. The trailer skirt according to claim 1, wherein the elongated planar surface comprises a plurality of panels configured and arranged in side-by-side, abutting connection with one another.

4. The trailer skirt according to claim 1, wherein the upper edge comprises a flange extending inwards towards the interior of the trailer.

5. The trailer skirt according to claim 1, wherein the elongated planar surface is substantially co-planar with an outer wall of the trailer.

6. The trailer skirt according to claim 1, further comprising a rear edge extending to the rear tires of the trailer and a front edge extending to the front tires of the trailer.

7. The trailer skirt according to claim 6, wherein the rear edge comprises a concave curve shape substantially corresponding to the shape of a rear tire of the trailer.

8. The trailer skirt according to claim 6, wherein the front edge comprises a convex curve shape.

9. The trailer skirt according to claim 1, wherein the plurality of dimples comprise one of inward depressions, protrusions and indentations formed within the elongated planar surface.

10. The trailer skirt according to claim 9, wherein the plurality of dimples comprise a plurality of shapes.

11. The trailer skirt according to claim 9, wherein the plurality of dimples comprise multi-sided polygonally shaped depressions.

12. The trailer skirt according to claim 9, wherein the plurality of dimples comprise frusto-spherical shaped depressions.

13. The trailer skirt according to claim 12, wherein the diameters of the frusto-spherical shaped depressions range from 3-4 inches.

14. The trailer skirt according to claim 12, wherein the diameter of the frusto-spherical shaped depressions is 3⅛ inches.

15. The trailer skirt according to claim 1, wherein the plurality of dimples comprises a matrix of substantially symmetrical dimples, dispersed symmetrically across the elongated planar surface.

16. The trailer skirt according to claim 1, wherein the vertical distance from the center of one dimple to the vertically adjacent dimple is fixed.

17. The trailer skirt according to claim 16, wherein the fixed vertical distance from the center of one dimple to the vertically adjacent dimple is 2⅜ inches.

18. The trailer skirt according to claim 1, wherein the horizontal distance from the center of one dimple to the horizontally adjacent dimple is fixed.

19. The trailer skirt according to claim 18, wherein the fixed horizontal distance from the center of one dimple to the horizontally adjacent dimple is 2⅜ inches.

20. The trailer skirt according to claim 1, wherein the depth of each dimple is fixed.

21. The trailer skirt according to claim 20, wherein the fixed depth of each dimple is ¼ inch.

22. The trailer skirt according to claim 1, wherein the trailer skirt is formed from a composite thermoplastic.

23. The trailer skirt according to claim 22, wherein the composite thermoplastic comprises a continuous fiber reinforced thermoplastic.

24. The trailer skirt according to claim 1, wherein the elongated planar surface has a thickness of ⅜ inches.

25. The trailer skirt according to claim 1, wherein the elongated planar surface has a height of 2 foot, 9 inches.
